(19) United States
(12) Patent Application Publication
(10) Pub. No.: US 2005/0053424 A1
(43) Pub. Date: Mar. 10, 2005

(54) Clamp holder for fixing connecting rods and/or slide rails with sliding elements guided thereon

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/487,982

(22) PCT Filed: Aug. 16, 2002
(86) PCT No.: PCT/EP02/09161

(30) Foreign Application Priority Data
Aug. 30, 2001 (DE) 10142122.2

(51) Int. Cl. F16B 1/00

(52) U.S. Cl. 403/390; 403/167

(57) ABSTRACT

The clamping holder engages around the slide rail or rod with a slide rail receptacle by more than half of the circumference in a frictional engagement. A hollow-cylindrical continuation of the slide rail receptacle engages over an adjusting bearing and a fastening member on the outside. The hollow-cylindrical continuation is secured to the adjusting bearing so as to be fixed with respect to displacement axially and is secured to a cup-like fastening bushing of the fastening member so as to be fixed with respect to rotation.

The invention is directed to a clamping holder for fastening connection rods and/or slide rails with sliding elements guided thereon according to the preamble of claim 1.

The brochure “Ordering and Construction Handbook, DORMA Manet, The Glass Design System”, printed June 1998, page 3/04, discloses “individual parts and mounting of a slide rail for wall fastening and glass fastening” in which unwanted, costly bore holes are required in the slide rail. Further, page 3/05 of the above-cited brochure shows slide rail clamping holders which are constructed from two parts with a plastic plate disposed therebetween, so that they can be placed on the slide rail with sufficient pressing force. The plastic insert described above is not desirable because of its wear behavior under continuous load. Further, the multiple-part construction, particularly of slide rail clamping holders over which rolling cars of a sliding door system run, leads to a more expensive production of the slide rail clamping holders mentioned above and requires a high precision, particularly in the area of the slide rail receptacle of the slide rail clamping holder so that the slide rail is supported without play in the slide rail receptacle of the slide rail clamping holder. Different distances from a substrate construction, particularly a wall, which vary over the length of a slide rail, a carrying bar or holding bar can not be compensated by the known devices.

Patent Application 101 19 908.2 describes a clamping holder which is supported by an end face of a hollow-cylindrical continuation of the slide rail receptacle directly at an end face of an adjusting bearing. The hollow-cylindrical continuation is fixed to the adjusting bearing by means of a fitting which is supported at the continuation so as to be rotatable and fixed with respect to axial displacement on the one hand and which is screwed to a cup-shaped fastening bushing on the other hand. The slide rail receptacle is prevented from rotating only by the pressing pressure of the hollow-cylindrical continuation against the adjusting bearing and this is not always sufficient in all cases of application because it can be detached easily.

It is the object of the invention to suggest a solution which makes it possible to fasten the slide rail receptacle to the fastening member so as to be fixed with respect to rotation while ensuring the advantages mentioned in the principal application in addition, wherein there is no need for an additional fitting.

The invention meets this object with the teaching according to claim 1.

As before, an adjustment of the adjusting bearing relative to the fastening member and, therefore, an adjustment of all adjacent adjusting bearings relative to one another is made possible in that the hollow-cylindrical continuation of the slide rail receptacle engages over the cup-like fastening bushing and the adjusting bearing, while on the other hand an advantageous fastening of the slide rail receptacle to the adjusting bearing and to the fastening member is also made possible in this way. In this way, it is possible for the slide rail receptacle to be secured to the adjusting bearing so as to be fixed with respect to axial displacement and to the cup-like fastening bushing of the fastening member so as to be fixed with respect to rotation in a simple manner.

Other features of the invention are characterized by the subclaims.

At least one circumferentially extending groove is arranged in the outer wall of the adjusting bearing and a knurling or serration extending in axial direction of the fastening bushing is arranged at the outer wall of the cup-like fastening bushing for fixing the slide rail receptacle to the adjusting bearing or to the fastening member.

In a further development of the invention, at least two threaded bore holes for receiving stud screws engaging through the wall are arranged for this purpose at a distance from one another in axial direction of the hollow-cylindrical continuation in the wall of the hollow-cylindrical continuation of the slide rail receptacle, wherein one of the spaced apart stud screws can be screwed into the groove arranged in the outer wall of the adjusting bearing and the other stud screw can be screwed into the area of the knurling or serration of the fastening bushing. Of course, a plurality of threaded bore holes in which corresponding stud screws securing the slide rail receptacle to the adjusting bearing and fastening member can be screwed can be applied over the longitudinal extension of the hollow-cylindrical continuation of the slide rail receptacle as well as over the circumference of the same. The rail clamping section of the slide rail receptacle can be constructed differently; the slide rail or the carrying bar or holding bar can be grasped by a little more than half of the circumference or completely. The slide rail or the carrying bar or holding bar can be secured additionally relative to the rail clamping section in that the rail clamping section has a threaded bore hole for receiving a stud screw.

Referring to the invention described above, by “slide rail” is meant a rail or a bar at which sliding elements of different types of construction, e.g., rollers, can be guided. However, the clamping holders described above can also be used in rails whose only function is to carry, e.g., curtains or the like. Further, the clamping holders are suitable for fastening, e.g., handle elements which were defined generically as holding rods.

The invention will be described more fully in the following with reference to an embodiment example.

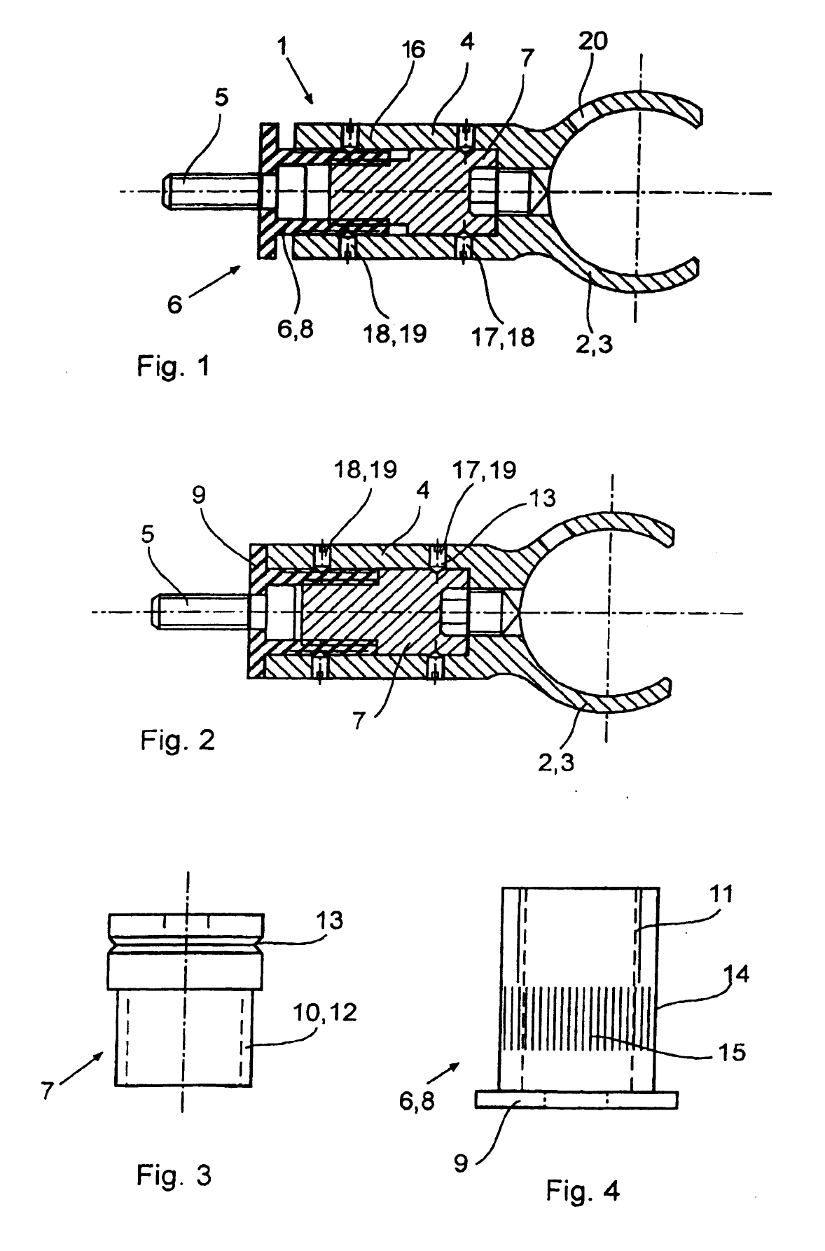

FIG. 1 shows a vertical section through a clamping holder;

FIG. 2 shows the section according to FIG. 1 with changed distance of the adjusting bearing;

FIG. 3 shows an enlarged view of an adjusting bearing;

FIG. 4 shows an enlarged view of the fastening member.

A clamping holder according to FIGS. 1 and 2 substantially comprises a slide rail receptacle 2 which forms an actual rail clamping section 3. A hollow-cylindrical continuation 4 proceeds from the slide rail receptacle 2 and engages on the outside over an adjusting bearing 5 and a cup-like fastening bushing 8 of a fastening member 6. The fastening member 6 has a cup base 9 which is clamped against the substrate construction, not shown, by means of a fastening screw 5.

It can be seen from FIG. 3 that an adjusting bearing 7 has an external thread 10 in the area of its outer wall 12, which external thread 10 (see FIG. 4) can be screwed into an internal thread 11 of the cup-like fastening bushing 8 of the fastening member 6. The adjacent adjusting bearings 7 can be aligned so as to be flush with one another by screwing the adjacent adjusting bearings 7 different distances into the fastening member 6. Further, it can be seen from FIG. 4 that a knurling 15 or serration extending in axial direction of the fastening member 6 is provided in the area of an outer wall 14 of the cup-like fastening bushing 8. The hollow-cylindrical continuation 4 of the slide rail receptacle 2 likewise engages over this knurling 15.

Insofar as the individual adjusting bearings 7 were aligned so as to be flush with one another before the slide rail receptacle 2 was placed on the adjusting bearing 7 or on the fastening member 6, a groove 13 arranged in the wall of the adjusting bearing 7 is likewise aligned. A plurality of stud screws 19 which engage through a wall 16 of the hollow-cylindrical continuation 4 and which can be screwed into threaded bore holes 17 can be inserted into this groove 13 viewed along the circumference of the hollow-cylindrical continuation 4 of the slide rail receptacle 2. In this way, the slide rail receptacle 2 is secured axially relative to the adjusting bearing 7 and accordingly relative to the fastening member 6. Other suitable stopping means can also be used instead of the groove 13.

Additional stud screws 19 which penetrate threaded bore holes 18 and can be adjusted toward the cup-like fastening bushing 8 in the area of the knurling 15 secure the slide rail receptacle 2 with respect to rotation relative to the fastening member 6.

The slide rail, not shown, can be secured relative to the rail clamping section 3 by means of another stud screw, not shown, which projects through a bore hole 20 in the rail clamping section 3.

Reference Numbers
1 clamping holder
2 slide rail receptacle
3 rail clamping section
4 hollow-cylindrical continuation
5 fastening screw
6 fastening member
7 adjusting bearing
8 cup-like fastening bushing
9 cup base
10 external thread
11 internal thread
12 outer wall
13 groove
14 outer wall
15 knurling
16 wall
17 threaded bore hole
18 threaded bore hole
19 stud screw
20 threaded bore hole

1-8. (cancelled).

9. A clamping holder for a slide rail, the clamping holder comprising:
a one-piece slide rail receptacle comprising a rail clamping section and a continuation having an axial bore facing away from the rail clamping section;
an adjusting bearing received in the axial bore and fixed against axial displacement relative to the continuation, the adjusting bearing having an external thread; and
a fastening member having a base for mounting on a substrate and a cup-like fastening bushing received in the axial bore of the continuation, the fastening bushing having an internal thread which engages the external thread of the adjusting bearing, the fastening bushing being fixed against rotation with respect to the continuation, whereby,
the distance between the rail clamping section and the base can be adjusted by rotating the adjusting bearing relative to the fastening member.

10. A clamping holder as in claim 9 further comprising means for locking the adjusting bearing with respect to the slide rail receptacle.

11. A clamping holder as in claim 10 wherein the locking means comprises a circumferential groove in the adjusting bearing.

12. A clamping holder as in claim 11 wherein said continuation has a wall provided with a threaded radial bore communicating with the axial bore, the clamping holder further comprising a stud screw received in the threaded radial bore in alignment with the circumferential groove.

13. A clamping holder as in claim 9 wherein the cup-like fastening bushing has an external wall provided axially extending knurling.

14. A clamping holder as in claim 13 wherein said continuation has a wall provided with a threaded radial bore communicating with the axial bore, the clamping holder further comprising a stud screw received in the threaded radial bore in alignment with the knurling.

15. A clamping holder as in claim 9 wherein the rail clamping section is designed to grasp a rail around at least half the circumference of the rail.

16. A clamping holder as in claim 9 wherein the rail clamping section has a threaded bore hole for receiving a stud screw.
